(19) United States
(12) Patent Application Publication
(10) Pub. No.: US 2005/0269804 A1
(43) Pub. Date: Dec. 8, 2005

(54) Cover of air bag apparatus and manufacturing method thereof

(76) Inventors: Satoshi Yamada, Fuji-shi (JP); Takahiro Suwama, Fujinomiya-shi (JP); Ryuji Sagisaka, Fuji-shi (JP); Tomotaka Ishikawa, Fujinomiya-shi (JP); Hideaki Saito, Fuji-shi (JP)

Correspondence Address: JOHN S. PRATT, ESQ;KILPATRICK STOCKTON, LLP, 1100 PEACHTREE STREET, ATLANTA, GA, 30309, US

(21) Appl. No.: 11/140,369

(22) Filed: May 27, 2005

(30) Foreign Application Priority Data
May 27, 2004 (JP) P2004-158324
Sep. 30, 2004 (JP) P2004-286868

(51) Int. Cl. B60R 21/20

(52) U.S. Cl. 280/728.3; 428/156

(57) ABSTRACT

A cover of air bag apparatus includes: a panel body made of resin including a door portion disposed opposing the air bag, a non-expansion portion which surrounds the door portion and a door peripheral portion defining the door portion and the non-expansion portion, containing a hinge opposing portion and a fracture portion to be fractured with a pressure when the air bag is expanded; a backing member made of resin including a door fixing portion welded to the door portion in the form of a sheet, a non-expansion portion fixing portion welded to the non-expansion portion in the form of a sheet and a hinge portion which is deformable, connecting the door fixing portion with the non-expansion portion fixing portion and disposed substantially opposing the hinge opposing portion; and a net body which is disposed across the hinge opposing portion and embedded integrally in a welding portion between the panel body and the backing member except a portion opposing the hinge opposing portion.

### BACKGROUND OF THE INVENTION

1. Field of the Invention

The present invention relates to a cover of air bag apparatus for a front seat passenger and manufacturing method thereof, and specifically to a cover which includes an interior material for covering the air bag expansion side of an air bag module aiming at protecting an occupant from an impact generated when a vehicle receives with shock, and more particularly to a cover of an air bag apparatus including an outer panel for covering the top face of the module and an inner panel disposed behind this outer panel.

2. Description of the Related Art

Conventionally, an air bag apparatus for a front seat passenger has been used, this air bag apparatus being disposed inside vehicle instrument panel. This air bag apparatus contains a box-shaped retainer and a folded air bag and an inflator for injecting gas for expanding this air bag are accommodated inside this retainer and an opening portion on the top of the retainer is covered with a cover (cover body) mounted along the instrument panel. Then, substantially C-shaped or substantially H shaped tear line as seen in plan view is formed to be capable of being fractured in this cover body and a section surrounded by this tear line is defined as a door portion. The bottom portion of this air bag is fixed to a reinforce disposed along the vehicle width direction inside the instrument panel and the top portion of the retainer is engaged with a mounting piece formed integrally on the back side of the cover body. Then, when a vehicle collides, the air bag is expanded by injecting gas from the inflator and the tear line is fractured with an expansion pressure of the air bag, so that with a portion in which no tear line is formed as a hinge, the cover body is opened like a door so as to form a projection port. The air bag is expanded through this projection port so as to ease an impact applied to a passenger.

A seamless instrument panel has been well known in which the cover body is formed integrally with the instrument panel in order to improve the appearance. The surface portion of the instrument panel is usually formed of relatively hard and brittle material such as polypropylene resin (PP) and the lid type cover body separate from the conventional instrument panel is formed of elastomer resin such as thermoplastic olefin (TPO), urethane base elastomer (IPU) and soft polyvinyl chloride (PVC). The resin used for the instrument panel and the resin used for the lid type cover body are different in terms of gloss, color tone, temperature characteristic and the like. If the lid type cover body is disposed in line with the instrument panel, their color tones are different and if the same surface treatment is made, for example, embossing is performed on the surface, their glosses are different. Further, because their linear expansion characteristics are different, any one member floats under high temperature condition so that it is waved. Thus, it is very difficult to match in visual or functional viewpoints.

Thus, in the seamless instrument panel, the door portion is formed integrally in the instrument panel with polypropylene resin and a separate member having a hinge portion formed of thermoplastic olefin is bonded to the back side of this polypropylene resin made member so as to harmonize the instrument panel with material used for the surrounding portion of this instrument panel in terms of appearance, tactile feeling and the like.

However, it is not easy to tear the hard resin with a certain behavior and open the hinge portion formed of soft resin as a fulcrum point in a wide temperature condition. For example, under extremely high temperature condition, the hinge portion is likely to be deformed excessively and fractured edges of hard resin interfere with each other, which is a problem desired to be solved.

As for this point, there has been well known such a structure in which the shape of a member formed of soft resin is modified to secure a space at a position opposing the hinge portion so as to suppress interference of fractured portions made of hard resin (see, for example, Japanese Patent Application Laid-Open No. 2004-58965 (page 7, FIGS. 3-6)). However, according to this structure, the structure is complicated and manufacturing cost is hard to reduce.

Such a structure in which a net is disposed between members to be welded by vibration welding so as to improve connection reliability when the cover body is expanded has been well known (see, for example, Japanese Patent Application Laid-Open No. 2002-46565 (page 4, FIG. 1B)). With this structure, the pitch of the net stitch is equalized with the pitch of ribs parallel to each other for vibration welding and the net is disposed such that it is dropped between a rib and another rib. However, this configuration can have a case where the net is not welded with the member and thus the behavior of a fractured member is not easily controlled stably and requires pitch control for equalizing the pitch of the rib with the pitch of the net, and as a consequence, it is difficult to reduce manufacturing cost.

Further, about the lid type cover body, such a structure in which reinforcement cloth is insert-molded has been well known (see, for example, Japanese Patent Application Laid-Open No. Hei-2-301414 (page 1, FIGS. 1-6)). However, it is not easy to insert mold the reinforcement cloth on part of the surface portion of the seamless instrument panel with a good appearance and in this case, manufacturing cost cannot be reduced easily.

As described above, today, a cover of air bag apparatus capable of reducing manufacturing cost and stabilizing its behavior has been demanded.

On the other hand, conventionally, this kind of automobile interior material, for example, instrument panel upper facia has an opening portion and when air bag is expanded, a lid body (expected door portion) covering this opening portion is tom out along a predetermined tearing expected line (fracture line) so as to form air bag expansion opening. Because the upper facia is formed of material having an appearance matching other compartment trims while the lid body is formed of soft resin material which can achieve a desired tearing characteristic, the lid body and the upper facia are lacking of a sense of unity and therefore, this is not a favorable embodiment in viewpoints of design.

As one of recent tends, a panel as large as covering the instrument panel upper facia is formed of material harmonious with tactile feeling and appearance of interior parts in the surrounding and a backing member (inner panel) is mounted on the back side so as to obtain a desired tearing characteristic (see, for example, Japanese Patent Application Laid-Open Nos. 2001-294114 and 2004-175305).

In the instrument panel having air bag described in the aforementioned Japanese Patent Application Laid-Open No. 2001-294114, a mounting bracket (equivalent to a backing member) having a plurality of protrusions on its top face is welded on the back side of an instrument panel in which perforations (tear line) are formed on the back side thereof by vibration. Because the mounting bracket can be mounted to the instrument panel without such a fixing means as rivet and screw, there are such effects that the quantity of components and the number of processing steps can be reduced.

Further, in the cover body of air bag apparatus described in the Japanese Patent Application Laid-Open No. 2004-175305, a supporting body (equivalent to a backing member) having a surface portion in which first rib portion and second rib portion are provided protrudedly in grid structure is welded on the back side of the cover body for covering an opening portion made in the instrument panel. By setting the width of the first rib portion to a time or more to three times or less the width of the second rib portion, the surface portion can be welded equally on the surface portion with a predetermined welding strength.

Usually, the surface portion of the instrument panel is formed of relatively hard and brittle material such as polypropylene (PP). On the other hand, the cover body of so-called lid type, which is separate from the conventional instrument panel, is formed of elastomer such as thermoplastic olefin (TPO), urethane base elastomer (TPU) and soft polyvinyl dichloride.

Resin used for the instrument panel and resin used for the lid type cover body are different in gloss, color tone, temperature characteristic and the like.

Thus, if the lid type cover body is disposed together with the instrument panel, its color tone differs and when the same surface treatment, for example, embossing is performed thereon, its gloss differs. Further, because the linear expansion coefficient differs, one of the members is floated or waved under high temperatures, so that it is difficult to match in terms of functions.

Then, for example, as an interior panel which is harmonious with material used for surrounding portions of the instrument panel in terms of beauty appearance and tactile feeling, efforts have been made to realize a seamless instrument panel by forming a door portion in the instrument panel with polypropylene resin integrally and joining a separate member having a hinge portion formed of thermoplastic olefin on the back side of this polypropylene made member.

However, it is not easy to tear out hard resin with a constant behavior or expand the hinge portion formed of soft resin as a fulcrum point in a wide temperature condition. For example, the hinge portion becomes likely to be deformed excessively under extremely high temperature condition and fractured edge portions of hard resin interfere with each other, which is a problem demanded to be solved.

To meet such problems, for example, a structure in which the shape of a member formed of soft resin is changed and by securing a space at a position opposing the hinge portion, an interference of fractured portions of hard resin is suppressed, has been well known (see, for example, Japanese Patent Application Laid-Open NO. 2004-58965.)

However, the structure disclosed in Japanese Patent Application Laid-Open NO. 2004-58965 contains such a new problem that the structure is complicated and reduction of manufacturing cost is disabled.

With the above-described structure, when the door portion rotates outward due to expansion and development of the air bag, the fixing portion side and the door reinforcement portion side of the hinge portion receive different stress. However, because in the interval portion between the fixing portion side and the door reinforcement portion side of the hinge portion has an equal thickness, the hinge portion is incapable of exerting a stress characteristic corresponding to the position in the hinge portion.

In some soft resin, its elongation (elasticity) drops under low temperature and in this case, this problem is met by adding a structural body. However, choice for material of the inner panel is narrowed and as a result, a necessity of utilizing an expensive material occurs to secure the physical property under low temperatures, thereby raising manufacturing cost.

Although it can be considered to make the hinge portion in a thin structure, if such a thin structure is adopted, the strength of the entire hinge portion may not be enough, which is not preferable.

### SUMMARY OF THE INVENTION

The present invention has been achieved with such points in mind.

It therefore is a first object of the present invention to provide a cover of air bag apparatus capable of reducing manufacturing cost and stabilizing its behavior and a manufacturing method of the same cover.

A second object of the present invention is to provide a cover of air bag apparatus capable of exerting stress characteristic corresponding to the position in the hinge portion in order to stabilize the expansion and development of the air bag while decreasing a manufacturing cost.

To achieve the above-described first object, according to a first aspect of the present invention, there is provided a cover of air bag apparatus for covering an accommodated air bag and in which a projection port for the air bag to project when the air bag is expanded is formed, comprising: a panel body made of resin including a door portion disposed opposing the air bag, a non-expansion portion which surrounds the door portion and a door peripheral portion defining the door portion and the non-expansion portion, containing a hinge opposing portion and a fracture portion to be fractured with a pressure when the air bag is expanded; a backing member made of resin including a door fixing portion welded to the door portion in the form of a sheet, a non-expansion portion fixing portion welded to the non-expansion portion in the form of a sheet and a hinge portion which is deformable, connecting the door fixing portion with the non-expansion portion fixing portion and disposed substantially opposing the hinge opposing portion; and a net body which is disposed across the hinge opposing portion and embedded integrally in a welding portion between the panel body and the backing member except a portion opposing the hinge opposing portion.

With this structure, when the air bag is expanded, the fracture portion is fractured with the pressure of the expansion and the hinge opposing portion is fractured or deformed. Then, at least part of the door portion is separated from the non-expansion portion so as to form a projection port of the air bag. When the fracture portion is fractured, the door portion is connected with the non-expansion portion through the backing member and rotates with the hinge portion as a fulcrum point. The door portion and the non-expansion portion are connected by the net body striding over the hinge opposing portion as well as the hinge portion, the behavior of the door portion is controlled so that the door portion is opened with a desired stabilized operation. The door portion and non-expansion portion of the panel body are welded on the door fixing portion and non-expansion portion fixing portion of the backing member in the form of a sheet and the net body is embedded integrally in the welding portion thereof and as a consequence, the panel body is fixed with the backing member firmly and the door portion is connected with the non-expansion portion securely.

According to a second aspect of the present invention, there is provided the cover of air bag apparatus according to the first aspect wherein the net body is provided with an allowance portion for connecting the side of the door portion with the side of the non-expansion portion with a longer distance than the shortest one at a place striding over the hinge opposing portion.

According to this structure, by setting the allowance portion, interference between edges of the fractured panel body is suppressed and the door portion is opened with a stabilized operation in a wide temperature range regardless of changes in the characteristic of resin.

According to a third aspect of the present invention, there is provided the cover of air bag apparatus according to the first or second aspect wherein the elongation characteristic of the net body is set to 40% higher than the elongation characteristic of the backing member or less.

According to this structure, by setting the elongation characteristic of the net body small, the welding portion is reinforced effectively.

According to a fourth aspect of the present invention, there is provided a manufacturing method of a cover of air bag apparatus for covering an accommodated air bag and in which a projection port for the air bag to project when the air bag is expanded is formed, wherein the cover comprises: a panel body made of resin including a door portion disposed opposing the air bag, a non-expansion portion which surrounds the door portion and a door peripheral portion defining the door portion and the non-expansion portion, containing a hinge opposing portion and a fracture portion to be fractured with a pressure when the air bag is expanded; a backing member made of resin including a door fixing portion welded to the door portion in the form of a sheet, a non-expansion portion fixing portion welded to the non-expansion portion in the form of a sheet and a hinge portion which is deformable, connecting the door fixing portion with the non-expansion portion fixing portion and disposed substantially opposing the hinge opposing portion; and a net body which is disposed across the hinge opposing portion and embedded integrally in a welding portion between the panel body and the backing member except a portion opposing the hinge opposing portion, in the above structure, the manufacturing method is operated step by step according to the following manners that the net body having a pitch different from the pitch of the rib is disposed between ribs provided protrudedly in a grid shape on any one of the panel body and the backing member and the other member of the panel body and the backing member and by making the ribs into a sliding contact with the other member, the ribs are welded so that the net body is embedded in a welding portion between the panel body and the backing member.

According to this structure, when the ribs provided protrudedly in a grid shape on one of the panel body and the backing member is welded on the other member of the panel body and the backing member by bring them in a sliding contact with each other, because the net body having a different pitch from the pitch of the ribs is disposed between these components, the net body is welded with both the components securely and embedded integrally in the welding portion. Further, because the net body makes a sliding contact with the face of the other member, its face is roughed so that welding of the panel body and the backing member is intensified. Then, in the cover formed in this way, when the air bag is expanded, the fracture portion is fractured with the pressure of its expansion and the hinge opposing portion is fractured or deformed, so that at least part of the door portion is separated from the non-expansion portion and a projection port of the air bag is formed. When the fracture portion is fractured, the door portion is connected with the non-expansion portion by the backing member and rotates with the hinge portion acting as a fulcrum point. In addition to this hinge portion, the door portion and the non-expansion portion are connected by the net body striding over the fractured portion so as to control the behavior of the door portion, so that the door portion is opened with a desired stabilize operation. The door portion and the non-expansion portion of the panel body are welded with the door fixing portion and non-expansion portion fixing portion of the backing member strongly and additionally, the net body is embedded in this welding portion. As a consequence, the panel body and the backing member are fixed easily and securely and the door portion is connected with the non-expansion portion securely, thereby leading to reduction of manufacturing cost.

The cover of air bag apparatus and manufacturing method of the present invention for the first aspect to the fourth aspects enable to provide a cover of air bag apparatus capable of reducing manufacturing cost and stabilizing its behavior.

In addition to the above aspects, to achieve the second object described above, according to a fifth aspect of the present invention, there is provided a cover (cover body) of air bag apparatus for covering an air bag accommodated in a folded condition and in which a projection port from which the air bag is projected when the air bag is expanded is formed, the cover (cover body) comprising: an outer panel of resin and an inner panel disposed on the back side of the air bag of the outer panel and so softer than the outer panel that it is deformable, wherein the outer panel comprises an expected door portion as an expansion portion opposing the air bag and a closed loop shaped fracture portion which sections between the expected door portion and a non-expansion portion and is fractured with a pressure at the time of the expansion of the air bag, the inner panel comprises a fixing portion to be fixed to the non-expansion portion, a door reinforcement portion to be fixed to the expected door portion and a hinge portion which is deformable and transverses the fracture portion to join the fixing portion with the door reinforcement portion integrally, and the hinge portion is expanded in a direction of leaving the outer panel and formed to be thinned gradually from the side of the fixing portion to the side of the door reinforcement portion.

Because the hinge portion in the cover (cover body) of the air bag apparatus of the fifth aspect is expanded in the direction of departing from the outer panel and at the same time formed to be thinned gradually from the side of the fixing portion in the inner panel to the side of the door reinforcement portion, when the air bag is expanded, the door reinforcement portion of the inner panel is pressed outward from inside so that the closed loop shaped fracture portion provided in the outer panel is fractured. When the door reinforcement portion and the expected door portion rotate outward integrally, the side of the fixing portion in the hinge portion is not easily deformed because it is thick and the side of the door reinforcement portion of the hinge portion is easily deformed because it is thin.

As a result, the intermediate point of the hinge portion is located at a lower position and the upper portion of the hinge portion is bent and deformed so that the door reinforcement portion and the expected door portion can be turned back along the surface of the outer panel like a snap action.

Further, fractured edge portions of hard resin never interfere with each other even in a wide temperature condition and choice for material of the inner panel can be widened. Further, with a simple structure in which the hinge portion is thinned gradually from the side of the fixing portion to the side of the door reinforcement portion, the expansion and development of the air bag can be stabilized.

According to a sixth aspect of the present invention, there is provided the cover body of air bag apparatus according to the first aspect wherein the door reinforcement portions are provided back and forth in the direction of vehicle traveling with the air bag mounted on the vehicle and the both door reinforcement portions comprise each hinge portion while at least one of which located on the side of an occupant is formed to be thinned gradually from the side of the fixing portion to the side of the door reinforcement portion.

With such a structure, in addition to the effect exerted by the fifth aspect of the present invention, the door on the occupant side of the two doors is turned back along the surface of the outer panel so that the air bag can be expanded quickly toward the stomach of the occupant.

According to the above-described structure of the present invention for the fifth and sixth aspects, the hinge portion in the cover body of the air bag apparatus is expanded in the direction of leaving the outer panel and formed to be thinned gradually from the side of the fixing portion in the inner panel to the side of the door reinforcement portion. As a result, the door reinforcement portion of the inner panel is pressed from inside to outside when the air bag is expanded and the closed loop shaped fracture portion provided on the outer panel is fractured. When the door reinforcement portion and the expected door portion rotate outward integrally, the side of the fixing portion in the hinge portion is not easily deformed because it is thick and the side of the door reinforcement portion in the hinge portion is easily deformed because it is thin.

As a consequence, the intermediate point of the hinge portion is located at a lower position and the upper portion of the hinge portion is bent and deformed, so that the door reinforcement portion and the expected door portion can be turned back along the surface of the outer panel like a snap action.

Additionally, fractured edge portions of hard resin never interfere with each other even in a wide temperature condition and choice for material of the inner panel can be widened. Further, with a simple structure in which the hinge portion is thinned gradually from the side of the fixing portion to the side of the door reinforcement portion, the expansion and development of the air bag can be stabilized.

### BRIEF DESCRIPTION OF THE ACCOMPANYING DRAWINGS

FIG. 1 is a sectional view taken along the line I-I of FIG. 3 indicating an embodiment of the cover of air bag apparatus of the present invention;

FIG. 2 is a exploded perspective view of part of the same cover,

FIG. 3 is a plan view of a condition in which net bodies are overlaid on the backing member of the same cover;

FIG. 4 is an explanatory diagram of the net body of the same cover,

FIGS. 5A and 5B are explanatory diagrams showing manufacturing process of the same cover, specifically FIG. 5A is a sectional view taken along the line VA-VA of FIG. 3 before welding with vibration and FIG. 5B is a sectional view taken along the line VB-VB of FIG. 3 after welding with vibration;

FIG. 6 is an explanatory diagram showing manufacturing process of the same cover;

FIGS. 7A and 7B are explanatory diagrams showing manufacturing process of the same cover, specifically FIG. 7A is a sectional view taken along the line VIIA-VIIA of FIG. 3 before welding with vibration and FIG. 7B is a sectional view taken along the line VIIB-VIIB of FIG. 3 at the time of the welding with vibration;

FIGS. 8A and 8B are explanatory diagrams showing the expansion behavior of the same cover, specifically FIG. 8A is a sectional view taken along the line VIIIA-VIIIA of FIG. 3 before expansion and FIG. 8B is a sectional view taken along the line VIIIB-VIIIB of FIG. 3 at the time of expansion;

FIGS. 9A and 9B are explanatory diagrams showing the expansion behavior of the same cover, specifically FIG. 9A is a sectional view taken along the line IXA-IXA of FIG. 3 before expansion and FIG. 9B is a sectional view taken along the line IXB-IXB of FIG. 3 at the time of expansion;

FIG. 10 is a sectional view taken along the line X-X of FIG. 3 showing other embodiment of the cover of air bag apparatus of the present invention;

FIG. 11 is a sectional view taken along the line XI-XI of FIG. 3 showing further other embodiment of the cover of air bag apparatus of the present invention.

FIG. 12 is a perspective view of an air bag apparatus having a panel main body for covering air bag module installed inside an instrument panel;

FIG. 13 is a back side view of the panel main body in FIG. 12;

FIG. 14 is a sectional view taken along the line XIV-XIV in FIG. 12;

FIG. 15 is an enlarged view of an encircled section XV in FIG. 14;

FIG. 16 is a sectional view taken along the line XVI-XVI in FIG. 12 at the initial period of air bag expansion;

FIG. 17 is a sectional view taken along the line XVII-XVII of FIG. 12 in conditions in which expansion of the air bag is advanced so that a door expected portion and a door reinforcement portion are fractured;

FIG. 18 is an enlarged view showing a normal condition in an encircled section XVIII in FIG. 14;

FIG. 19 is an enlarged view showing a condition in which the door expected portion and door reinforcement portion in an encircled section XIX of FIG. 3 are fractured;

FIG. 20 is an enlarged view showing a condition in which an air bag in an encircled section XX of FIG. 3 is expanded completely; and

FIG. 21 is an operation diagram for explaining a condition in which the air bag is expanded completely.

### DETAILED DESCRIPTION OF THE PREFERRED EMBODIMENTS

There will be detailed below the preferred embodiments of the present invention with reference to the accompanying drawings. Like members are designated by like reference characters.

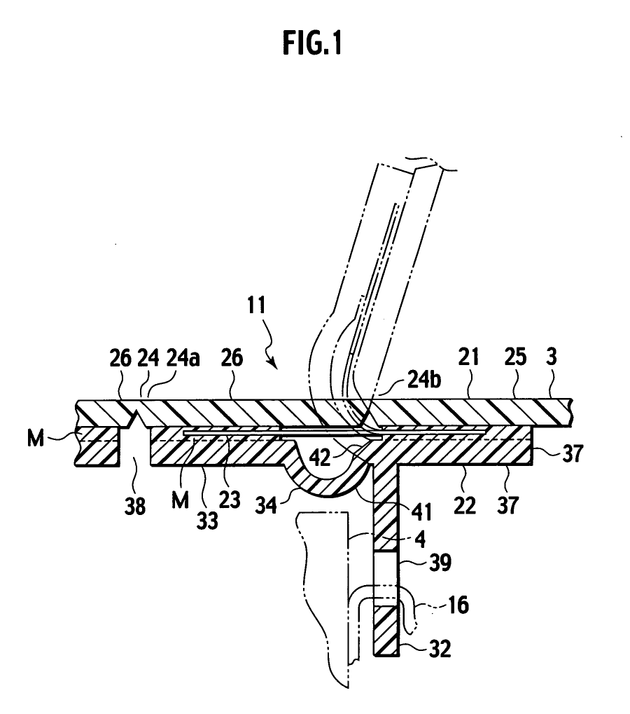

Referring to FIG. 1, for a first embodiment of the present invention, reference numeral 1 denotes an air bag apparatus, which constitutes an air bag apparatus 1 for a front sheet passenger equipped in an instrument panel portion 3 of vehicle. The instrument panel 3 is provided over substantially entire length in the vehicle width direction of the front portion of a vehicle compartment and a front window glass is located above this instrument panel portion 3. The air bag apparatus 1 is accommodated inside this instrument panel portion 3 such that it opposes a front seat passenger. This air bag apparatus comprises a case body 4 called retainer or reaction can, an inflator (not shown) attached to the bottom portion of this case body 4, an air bag (not shown) accommodated in a folded condition above the inflator and a cover (cover body) 11 for covering an opening portion in the upper portion of the case body 4. This air bag apparatus 1 is mounted on a vehicle body by fixing the case body 4 to a reinforce of the vehicle body through a bracket. On the front face and rear face of the top portion of the case body 4 are attached hooks 16 having a substantially C-shaped section which engage a cover 11. As the inflator, various kinds of inflators are used such as combustion type (pyrotechnik type, pyrotechnics type) and a type in which compressed gas is deposited.

If a vehicle equipped with this air bag apparatus 1 receives with shock, the air bag is expanded with gas supplied from the inflator and the cover 11 is fractured with this expansion pressure so as to form a projection port 18 and then, the air bag is projected in a predetermined direction on the expansion side, so that it is expanded and developed in front of a passenger. In the meantime, in a below description, it is assumed that the predetermined direction on the expansion side of the air bag is upward or surface side while an opposite direction to the expansion side is downward or back side. Further, the back and forth direction and both side direction when this air bag is mounted on a vehicle are assumed to be the back and forth direction and both side direction.

As shown in FIGS. 1-3, the cover (cover body) 11 includes a panel body 21 constituting the instrument panel, a backing member 22 attached to the back side of this panel body 21 by vibration welding and a pair of front and rear net bodies 23, 23 which are reinforcement members embedded integrally in a welding portion M. The welding portion is a joining portion between the panel body 21 and the backing member 22. More specifically, the backing member 22 is integrally welded (melted) by applied with vibration on the back side of the panel in a manner of insert-molding operation. The cover (cover body) 11 constitutes a member called seamless instrument panel, seamless inner panel or seamless lid, which is provided integrally with the instrument panel portion 3.

The panel body 21 is called surface panel, outer portion, outer panel portion, lid outer or instrument panel main body, provided substantially in the form of a sheet so as to cover the front surface side of the instrument panel portion 3 integrally or substantially over an entire length in the vehicle width direction of the front portion of the vehicle compartment. This panel body 21 is an injection molded product of olefin resin such as hard polypropylene resin and the surface is subjected to delustering embossing in order to prevent itself from being reflected to a front window glass and obtain an appearance similar to leather feeling. As resin constituting the panel body 21, a hard resin having a bending modulus of 2969 [MPa] (30300 [kgf/cm2]) or more, preferably a bending modulus of 1078 [MPa] (11000 [kgf/cm2]) or more, further preferably 1862 [MPa](19000 [kgf/cm2]) or more is used. More specifically, in addition to the aforementioned polypropylene, for example, vinyl chloride, ABS, modified polyphenylene oxide (PPO), polycarbonate or composite resin created by combining these are available. As this composite resin, for example, composite resin of polycarbonate and ABS can be used. Further, it is permissible to use composition technology usually used in a corresponding field or relating field, for example, adding various additives such as talc, whisker, titan white or the like for adjusting the physical property and color tone.

On the back side of this panel body 21 is formed a door peripheral portion 24 substantially opposing the opening portion in the top of the case body 4 and an outer portion 25 as a non-expansion portion and rectangular door portions 26, 26 in pair, front and rear, surrounded by the outer portion 25 opposing the air bag are defined. The door portions 26, 26 cover the expansion side of the air bag accommodated in a folded condition. The door peripheral portion 24 is a tear line which is a weak portion capable of being fractured, called tear, tear groove, fracture expected line, fracture line, opening expected line or opening expected thin groove or of closed loop having at least a straight portion. According to this embodiment, this closed loop shape is composed of a rectangular tear line combination of a central tear line 24a as a fracture portion extending in the center to both sides, front/rear tear lines 24b, 24b acting as a hinge opposing portion which runs with the hinge to constitute the outer contour, and both side tear lines 24c, 24c located on both sides of the fracture portion. The door peripheral portion 24 is injection molded at the same time when the panel body 21 or after the panel body 21 is formed, grooves are formed in its flat portion with a rotating blade such as milling cutter. Its thinnest portion is formed in the thickness of 0.3 mm to 1.5 mm, more preferably 0.5 mm to 0.7 mm.

On the other hand, the backing member 22 is a soft resin made member formed of material softer than material constituting the panel body 21 and deformable, called backing, backing member, inner portion, inner member or lid inner. It is larger than the total door portion 26 in its plan view and located inside and outside the door peripheral portion 24 so that it is welded on the back side of the panel body 21 in the form of a sheet That is, this backing member 22 is joined with the door portion 26 on the back of the panel body 21 and the outer portion 25 around this door portion 26. Then, the backing member 22 is constructed with injection molded components of thermoplastic olefin (TPO) resin or various soft elastomer resins such as TPU (urethane base), TPE (polyester base), SES, SEBS (styrene base) are applicable as well as the TPO resin. As its bending modulus, it is possible to select for example, 274 [Pa] (2800 [kgf/cm2]), preferably 588 [MPa] (6000 [kgf/cm2]) or less, more preferably 441 [MPa] (4500 [kgf/cm2]) or less.

The backing member 22 is comprised of a rectangular inner contour portion 31 which is an outer peripheral portion fixed to the back side of the outer contour portion 25 of the panel body 21, a square piped mounting piece portion 32 provided protrudedly downward from an end portion on the inner periphery side of the inner contour portion 31, door reinforcement portions 33, 33 which are rectangular door fixing portions fixed to the back side of the respective door portions 33, 33 located on the inner periphery side of the inner contour portion 31 and a plurality of hinge portions 34 which couple the outer contour portions of the door reinforcement portions 33, 33 with the front/rear mounting piece portions 32, these components being integrated. Then, the inner contour portion 31 and the mounting piece portion 32 constitute a non-expansion fixing portion 37. A cutting portion 38, which is a concave gap portion having a small width, is formed between the respective door portions 26 and 26 and along the short sides of the respective door portions 26, 26, namely, at the position opposing the central tear line 24a and the short sides of the both side tear lines 24c, in a substantially H shape as seen in plan view.

The mounting piece portion 32 is called connecting piece, peripheral wall or retainer mounting vertical wall and located along the outer periphery of the tear lines 24b, 24b, 24c, 24c constituting the contour of the door reinforcement portions 33, 33 or along a position in the vicinity of the outer periphery of these tear lines 24b, 24b, 24c, 24c. Then, faces of the mounting piece portions 32 opposing in the back and forth direction serve as a pair of engaging portions, front and rear. A rectangular mounting hole 39 is formed in each engaging portion and a hook 16 provided on the case body 4 is engaged in the engaging hole 39.

Each door reinforcement portion 33 can be called flap and has a slightly smaller area than each door portion 26. This door reinforcement portion 33 is formed from a position along the central tear line 24a up to a position slightly apart from the mounting piece portion 32.

Welding ribs 40 are provided on the inner contour portion 31 and the door reinforcement portions 33, 33 of the backing member 22 in a grid shape such that they are protruded from a face opposing the panel body 21 toward the side of this panel body 21 before the backing member 22 is welded to the panel body 21. By bringing this welding ribs 40 into a sliding contact with the bottom face of the panel body 21 and welding these ribs 40, the inner contour portion 31 and the door reinforcement portions 33, 33 of the backing member 22 are welded onto the outer contour portion 25 and the door portions 26, 26 of the panel body 21 through each surface so as to form a welding portion M.

The hinge portions 34 are deformable or flexible and disposed sequentially along portions opposing part of the door peripheral portion 24 or according to this embodiment, portions opposing the front and rear tear lines 24b, 24b or in plural quantity, for example, five at a specified interval for connecting each door reinforcement portion 33 with the mounting piece portion 32 and the inner contour portion 31 across the front and rear tear lines 24b, 24b, that is, each door reinforcement portion 33 with the non-expansion fixing portion 37 flexibly. This hinge portion 34 has a curved portion 41 having an arc shaped section or a substantially U-shaped section or substantially V-shaped section such that it is expanded in a direction of leaving the panel body 21 or downward, and according to this embodiment, an inclined face 42 is formed at a position substantially opposing the tear line 24b at an end portion of the mounting piece portion 32 such that it is inclined downward toward the curved portion 41.

The net body 23 can be called reinforced net material or hinge reinforcement net and its melting temperature or decomposition temperature is higher than those of the panel body 21 and the welding rib 40 of the backing member 22. This net body 23 uses fiber yarns which are not melted by friction with other member in the vibration welding process, for example, chemical yarn such as polyester fiber, nylon fiber, natural fiber such as cotton, hemp or mixed yarn of chemical/natural fiber is used. It is formed into mesh structure with a predetermined pitch and entirely in a substantially rectangular shape. As for the predetermined pitch, as shown in FIG. 4, preferably a dimension L1 between a vertical yarn 44 and another vertical yarn 44 and a dimension L2 between a lateral yarn 45 and another lateral yarn 45 is, for example, in a range of 1.0 mm to 30 mm and this pitch is set different from the pitch of the welding ribs 40 formed on the inner contour portion 31 and the door reinforcement portions 33, 33 of the backing member 22 before welding.

Each net body 23 is disposed between the panel body 21 and the backing member 22 across the front/rear tear lines 24b, that is, from between the door portion 26 and the door reinforcement portion 33 to between the outer contour portion 25 and the inner contour portion 31. Between the door portion 26 and the door reinforcement portion 33 and between the outer contour portion 25 and the inner contour portion 31, resin melted in a sheet shape is impregnated into fibers so that the net body is embedded integrally in the welding portion M.

Next, the manufacturing process of this cover 11 will be described.

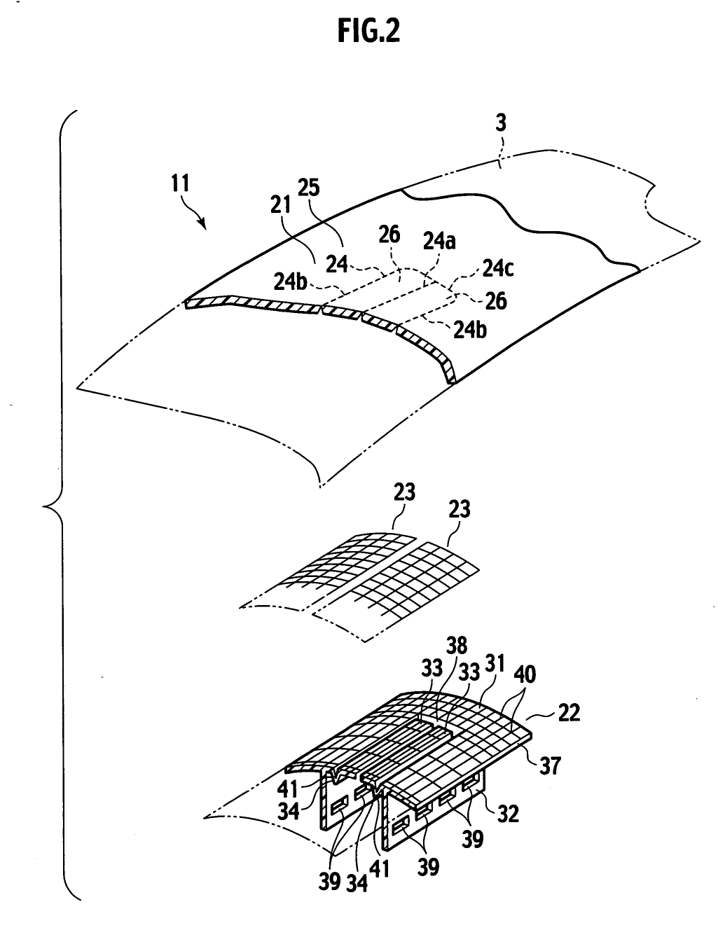

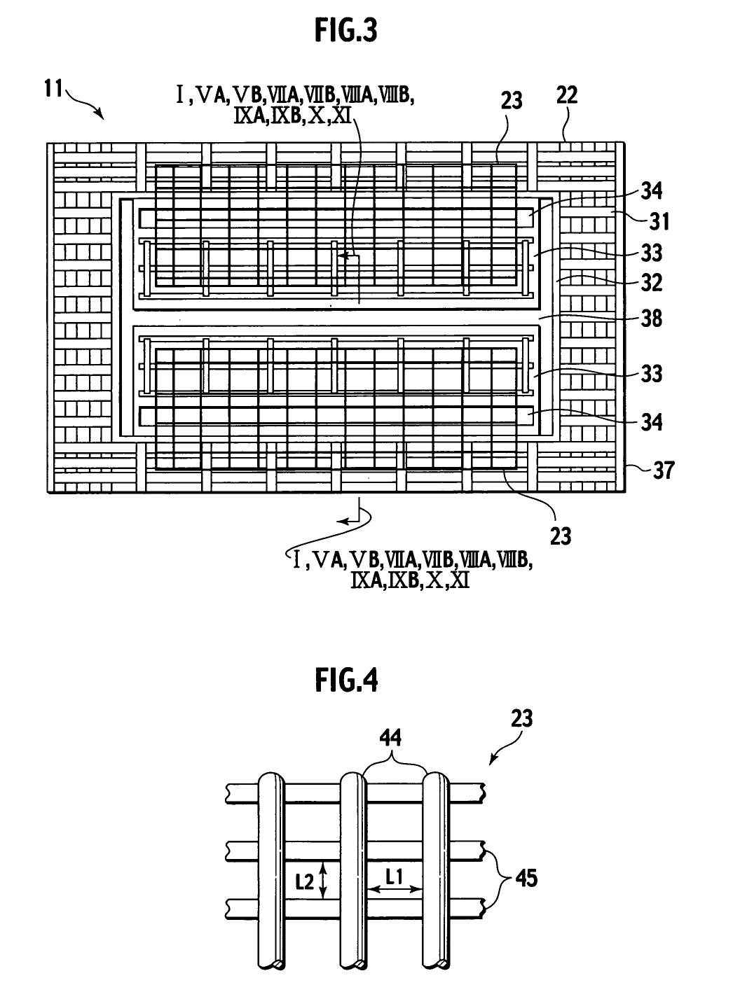

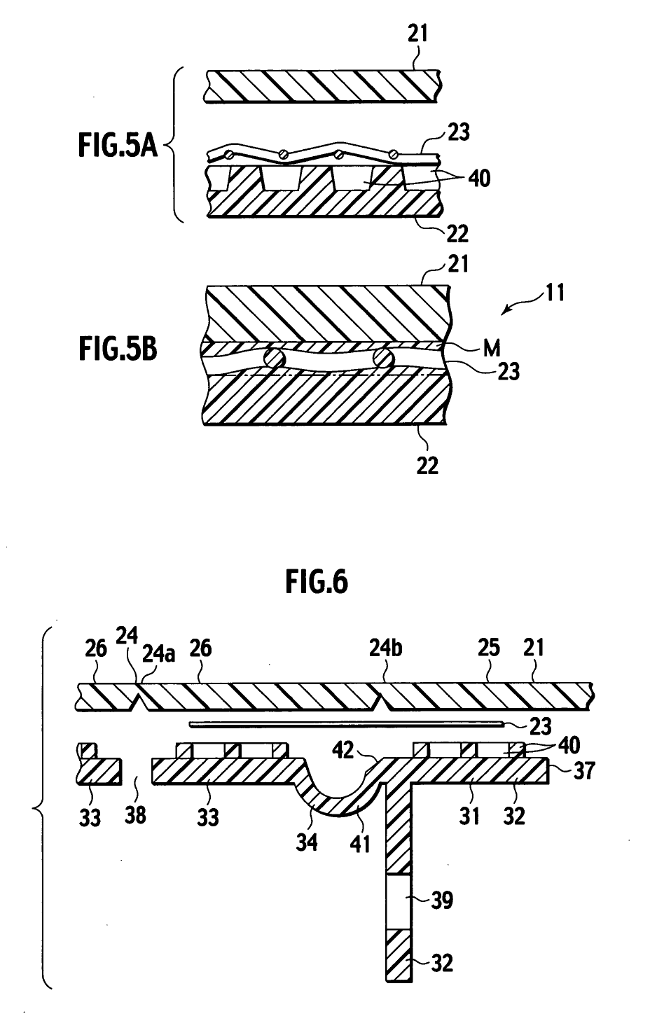

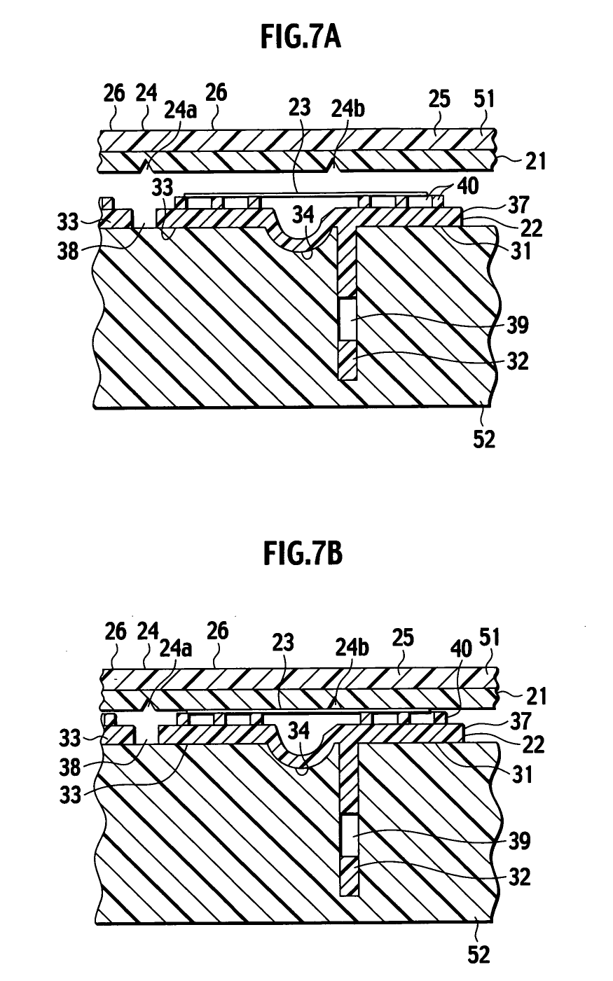

First, as shown in FIGS. 2 and 6, the preliminarily formed panel body 21, backing member 22 and net body 23 are prepared. Then, the panel body 21, the backing member 22 and the net body 23 are disposed between an upper jig 51 and a lower jig 52 constituting a manufacturing unit as shown in FIG. 7A. The backing member 22 is placed on the lower jig 52 and the panel body 21 is attached to the upper jig 51 and then, as shown in FIGS. 3 and 5A, the net body 23 is disposed at a predetermined position between the panel body 21 and the backing member 22. Then, with the upper jig 51 and the lower jig 52 approaching each other, as shown in FIG. 7B, the panel body 21 and the backing member 22 are pressurized across the net body 23 to press each other at a predetermined force. With this condition, by vibrating the upper jig 51 and the lower jig 52 relatively in a horizontal direction, vibration welding is carried out in which the panel body 21 and the backing member 22 are vibrated relative to each other. As a consequence, the welding ribs 40 and the panel body 21 are partly fused by frictional heat so that the door portion 26 and the door reinforcement portion 33 are welded together in the form of a sheet while the outer contour portion 25 and the inner contour portion 31 are welded together in the form of a sheet.

In this welding process, as shown in FIG. 5B, the net body 23 is embedded in the welding portion M except portions opposing the hinge portion 34 and the door peripheral portion 24. That is, the welding ribs 40 of the backing member 22 passes through seams of the net body 23 in fused condition and join with the panel body 21 and consequently, the panel body 21, the backing member 22 and the net body 23 are fixed firmly such that they are entangled with yarns of the net body 23.

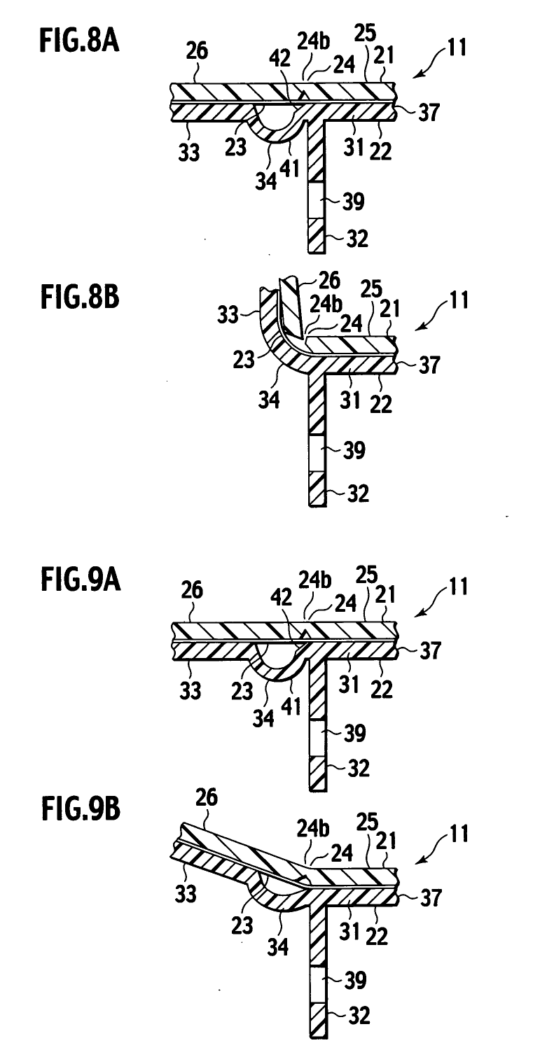

When the air bag apparatus 1 equipped with the cover 11 having such a structure is operated, if gas flows into the air bag so that the air bag is expanded and developed from the condition shown with a solid line in FIG. 1 and FIG. 8A, the air bag is expanded within the case body 4 and the door portion 26 of the panel body 21 is pushed through the door reinforcement portion 33 of the backing member 22 with that expansion force and then, the door peripheral portion 24 is broken along its entire length or with part left so as to separate the front and rear door portions 26 from the outer contour portion 25. That is, although as for the door peripheral portion 24, the central portion and both side tear lines are cut out completely, the front and rear tear lines 24b are cut out completely or in other case, part is left without being cut out.

If the air bag is expanded, the front and rear door portions 26, after pushed by the door reinforcement portion 33, rotates with the hinge portion 34 and an exposed portion of the net body 23 as a fulcrum point so that as shown in FIGS. 1 and 8B, a projection port 18 of the air bag is formed.

According to this embodiment, the backing member 22 made of soft resin having the welding ribs 40 provided protrudedly and the panel body 21 made of hard resin are bonded together by vibration with the reinforcement net body 23 sandwiched and the net body 23 is disposed across the hinge portion 34, namely a portion opposing the door peripheral portion 24. Thus when the air bag is expanded, behavior of an edge portion of a broken panel body 21 along the door peripheral portion 24 can be controlled stably to a desired behavior at a position overlapping the hinge portion 34. Even if easiness of bending of the hinge portion 34 is changed depending on temperature condition, for example, interference of an edge of the door portion 26 with an edge of the outer contour portion 25, sliding of doors called door slide phenomenon, riding over and drop-in can be suppressed and the door portion 26 can be opened smoothly around a certain fulcrum point, that is, with a virtual line along the hinge portion 34 as a bending line. As a result, it is possible to provide a seamless instrument panel in which the degrees of the expansion and development of the air bag do not differ depending on changes of temperature condition and air bag projection port is formed with desired stable characteristics by improving temperature-operation reliability.

By carrying out the vibration welding with the net body 23 disposed between the panel body 21 and the backing member 22, the net body 23 can be welded easily in the welding portion M of the panel body 21 and backing member 22 and as compared with a structure using insert molding, the structure and manufacturing process can be simplified to thereby reduce manufacturing cost. Then, by using the net body 23 made of fibers, characteristic of flexibility and difficulty to be cut out or torn can be provided easily as compared with for example, TPO resin made member. Further, because melted resin is impregnated into between fibers, the panel body 21, the backing member 22 and the net body 23 are joined together firmly.

According to this embodiment, the welding ribs 40 on the backing member 22 are formed in a grid shape and the pitch of stitch of the net body 23 is set different from the pitch of the grid of the welding rib 40. Thus, in the manufacturing process, when the net body 23 is placed on the welding ribs 40, the net body 23 does not drop in between the welding ribs 40 but as shown in FIG. 5B, is placed on the welding ribs 40. Then, in a process of vibration welding, the net body 23 is in a sliding contact with the welding ribs 40 of the backing member 22 so as to melt the TPO resin of the backing member 22. It is in a sliding contact with the panel body 21 also so as to melt polypropylene resin of the panel body 21 with heat generated by friction with fibers of the net body 23. Particularly in an initial condition of the vibration welding, due to not only a relative move between the TPO resin of the welding ribs 40 slightly melted and fibers in the vibration welding but also a relative move between the fibers and the polypropylene resin of the panel body 21 or olefin resin, the face to be bonded of the panel body 21 is roughed, so that surface activity or welding performance is intensified. By impregnating yarns of fibers constituting the net body 23 completely in the welding portion M so as to form so-called fiber reinforced resin, it is possible to provide the cover 1 in which the panel body 21, backing member 22 and net body 23 are joined together firmly.

Further because the substantially U-shaped curved portion 41 is provided in the hinge portion 34 of the backing member 22, even if elongation of resin is small under condition of low temperatures, an edge portion of the door portion formed by fracture is accommodated in the curved portion 41 so that the door portion can be developed smoothly in a wide temperature range. Further because this hinge portion 34 is provided with the inclined face 42 which is inclined downward toward the curved portion 41, the edge portion of the door portion 26 is guided by this inclined face 42 when the doors are opened, thereby realizing smooth expansion of the door portions 26.

In this way, the instrument panel 3 and material used for the peripheral portion of the instrument panel 3 match with each other in terms of beauty and tactile feeling, thereby preventing design performance from being lost by existence of the door portion 26 of the air bag apparatus 1. As a result, it is possible to provide a seamless instrument panel capable of reducing manufacturing cost and maintaining a stabilized shape in a wide temperature range.

Meanwhile, preferably, the elongation characteristic of the net body 23 is set to 40% higher than the elongation characteristic of the backing member 22 or less. That is, because the elongation characteristic of the TPO resin of the backing member 22 constituting the welding portion M is about 140%, by setting the elongation characteristic of the net body 23 to 200% or less which is 40% plus, the elongation characteristic of the net body 23 can be approached to the elongation characteristic of the welding portion M so as to suppress the elongation of the TPO resin at a portion in which the net body 23 is welded thereby securing reinforcement effect.

In the vibration welding process, by vibrating the upper jig 51 or the panel body 21 and the lower jig 52 or the backing member 22, the vibration welding can be carried out.

Further, in the vibration welding process, by fixing the net body 23 to any one of the panel body 22 and the backing member 22 temporarily, the net body 23 can be positioned accurately and welded.

Further, the net body 23 can be provided with a curved allowance portion at a portion across the door peripheral portion 24. That is, this allowance portion connects the side of the door portion 26 with the side of the non-expansion fixing portion 37 with a length larger than a shortest distance and by setting the allowance portion in which the net body 23 is disposed loosely along the hinge portion 34, interference of a broken edge portion with the net body 23 is suppressed and an opening angle of the door portion 26 can be secured sufficiently under low temperatures as well as normal temperature and high temperatures. As a result, the operation can be stabilized easily in a wide temperature range regardless of changes in the characteristic of resin.

Although the net body 23 needs to stride over a portion acting as a fulcrum point when the door portion 26 is opened, the tear line 24b acting as a fulcrum point of the door peripheral portion 24 does not always need to be cut off completely but as shown in FIG. 9A, 9B, it can be kept connected without being cut off. Then, the shape of the tear line 24b which is the hinge opposing portion is not limited to triangular section which induces breaking easily but is permitted to be of step portion having for example, substantially trapezoidal section or a shallower groove than other tear lines.

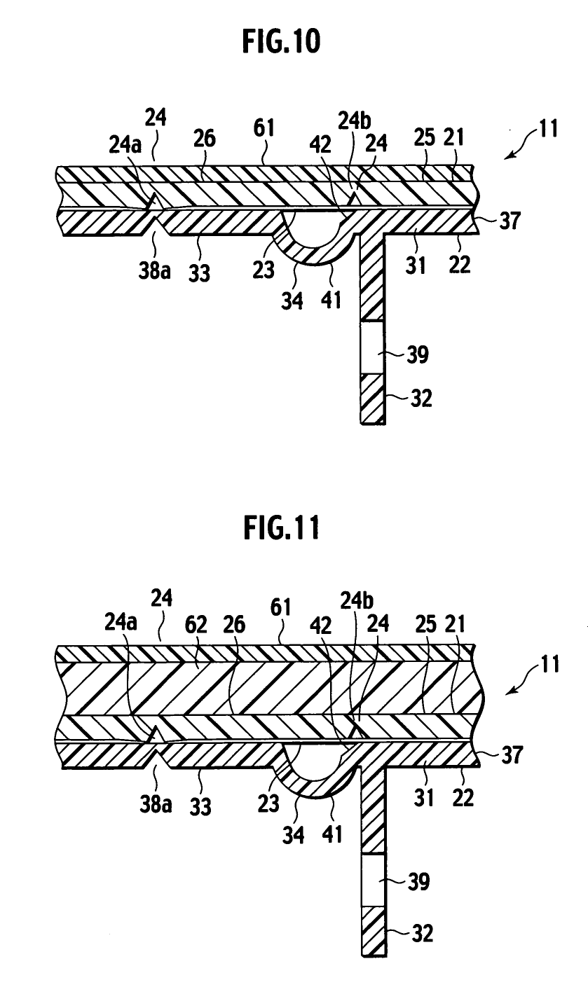

Further, the panel body 21 made of hard resin is not limited to single layer but if it is composed of plural layers, the same effect that its expansion behavior is stabilized by the net body 23 can be obtained. For example, as shown in FIG. 10, surface material 61 made of soft resin such as urethane about 1 mm thick may be provided on the surface of the panel body 21 made of hard resin acting as core for decoration. As shown in FIG. 11, it is permissible, for example, to form foamed layer 62 made of soft resin on the surface of the panel body 21 made of hard resin acting as core and further provide the surface material 61 made of soft resin on the surface of this foamed layer 62. In the structures shown in FIGS. 10, 11, instead of the cutting portion 38, tear line 38a which is a fracture portion which can be broken is formed at a portion opposing the central tear line 24a in the backing member 22. Although not shown, the fracture portion which facilitates fracture may be formed in the foamed layer 62 and the surface material 61.

Although in the above-described respective embodiments, a double flap structure in which the front and rear door portions 26, 26 in pair are equipped and they are opened both ways in the back and forth direction has been indicated, the present invention is not restricted to this structure but it is permissible to form a single flap in which a single door portion is provided by being defined by a substantially rectangular door peripheral portion and a door portion formed by breaking of part or all of this door peripheral portion is opened in the forward direction of a vehicle.

By disposing the net body 23 over a substantially entire length of the front and rear hinge portions 34, the expansion behavior of each door portion 26 can be controlled uniformly along the length direction. In the meantime, depending on the characteristic of resin of the panel body 21 and the backing member 22 and the shape of the door peripheral portion 24, the net body 23 may be disposed only on one door portion 26 or may be disposed only along part of each hinge portion 34.

The present invention can be applied to not only a cover of an air bag apparatus for a front passenger of the instrument panel but also a cover of an air bag apparatus disposed at other place as an interior panel.

A second embodiment of the present invention will be described with reference to the accompanying drawings hereinafter.

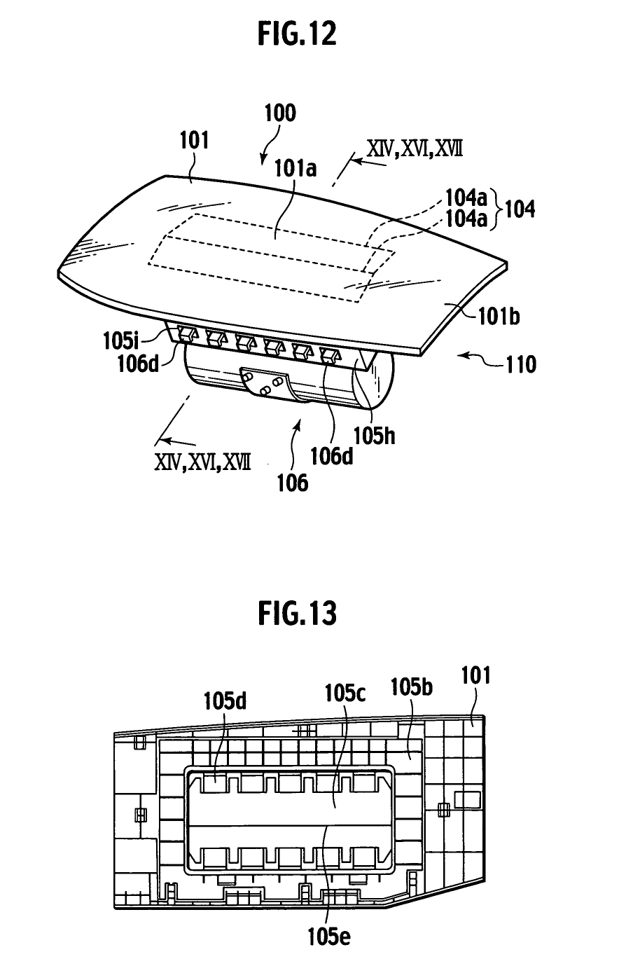

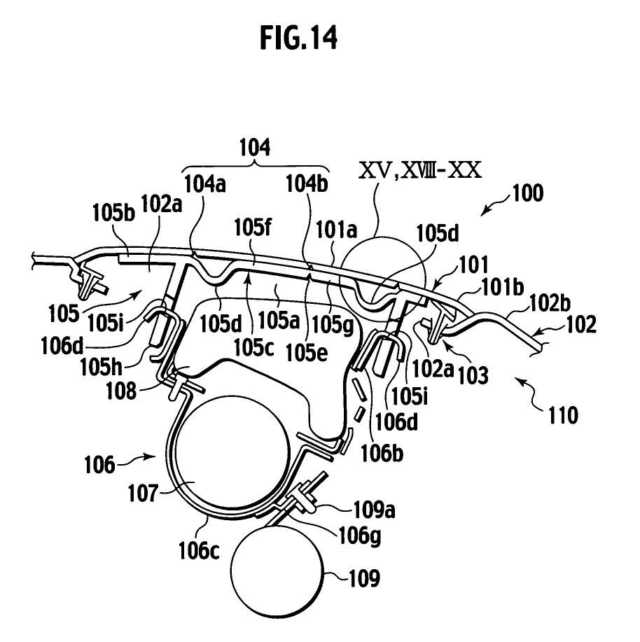

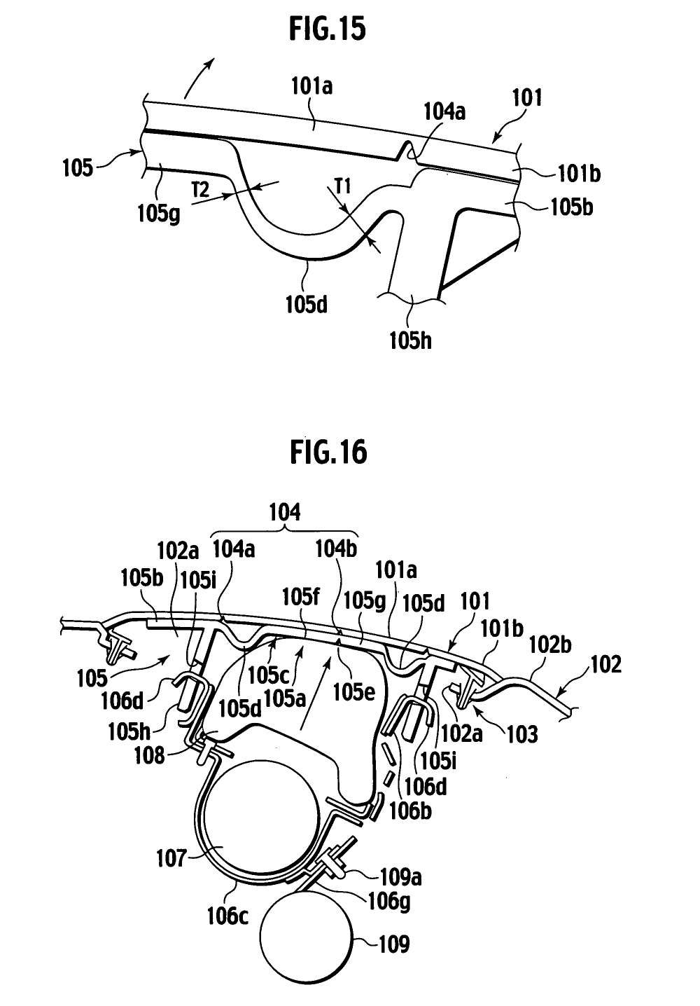

FIG. 12 is a perspective view of an air bag apparatus having a cover (cover body) 100 for covering an air bag module installed inside an instrument panel 102 of a vehicle. FIG. 13 is a back side view of the panel main body, FIG. 14 is a sectional view taken along the line XIV-XIV of FIG. 12 and FIG. 15 is an enlarged view of an encircled section XV in FIG. 13.

The instrument panel 102 shown in FIGS. 12, 13 is provided with an opening portion 102a which is a projection port of an air bag 108 at an opposing face 102b opposing a vehicle compartment. And the opening portion 102a of the instrument panel 102 is covered with the cover 100 which includes an outer panel (panel main body) 101 constituting automobile interior material and an inner panel (backing member) 105. The outer panel 101 is constructed to cover an opening portion 102a provided on the opposing face 102b opposing the vehicle compartment of the instrument panel 102 mounted on the front portion of a vehicle compartment such that it is tilted in the back and forth direction at substantially the same angle as the opposing face 102b of the instrument panel 102 in the back and forth direction.

The opening portion 102a of the instrument panel 102 is open in front of an occupant seat (not shown) and an engaging means 103 for engaging the outer panel 101 is provided along an inner periphery of the opening portion 102a of the instrument panel 102.

The outer panel 101 is formed integrally of thermoplastic resin of the same color and material as the instrument panel 102, for example, polypropylene containing talc (PP composite) so that no feeling of disharmony is generated relative to the instrument panel 102 when it is mounted on the opening portion 102a of the instrument panel 102. This outer panel 101 is comprised of an expected door portion 101a acting as an expansion portion opposing the air bag module 106 and a non-expansion portion 101b which is sectioned by the expected door portion 101a and a fracture portion 104.

The fracture portion 104 is called tear line portion and provided concavely in the back side of the outer panel main body 101 so that it is fractured with a pressure when the air bag 108 is expanded and is formed in a closed loop with an outer peripheral line (frame-like portion) 104a and a central line 104b.

More specifically, the inner panel (backing member) 105 is integrally welded (melted) by applied with vibration on the back side of the outer panel 101 in a manner of insert-molding operation. The inner panel (backing member) 105 is formed with (made of) thermoplastic resin softer than the inner panel 105, for example, olefin base elastomer (TPE) or polyester base elastomer (TPEE) so that the inner panel is soft enough to be deformable.

The inner panel 105 is formed into a frame having a substantially as large opening portion 105a as the frame-like portion 104a of the fracture portion 104 formed on the back side of the outer panel 101 and comprised of a fixing portion 105b which is fixed to the non-expansion portion 101b of the outer panel 101, a door reinforcement portion 105c which is fixed to the expected door portion 101a of the outer panel 101 by vibration welding or the like and hinge portions 105d which transverse the frame-like portion 104a of the fracture portion 104 on the side of the outer panel 101 to join the fixing portion 105b with the expected door portion 105c.

A fracture line 105e is formed opposing the central line 104b of the fracture portion 104 in the back side of the door reinforcement portion 105c and divided door reinforcement portions 105f, 105g are provided by dividing the door reinforcement portion 105c back and forth in a vehicle advancing direction across the fracture line 105e. As described above, the divided door reinforcement portions 105f, 105g are joined with the fixing portion 105b through the hinge portion 105d. As for at least the hinge portion 105d on the side of the occupant of those hinge portions, if it is assumed that the thickness on the side of the divided door reinforcement portion 105g is T2 and the thickness on the side of the fixing portion 105b is T1, there is a relation of T1>T2 as shown in detail in FIG. 4, so that the thickness decreases gradually as it goes from the side of the fixing portion 105b to the side of the door reinforcement portion 105c.

Further, the air bag module 106 has a upper retainer 106b and a lower retainer 106c, which are formed of metal sheet and the lower retainer 106c accommodates an inflator 107 for injecting high pressure gas, thereby constituting an air bag apparatus 110.

Engaging pawls 106d composed of plural hooks are fixed on the outer peripheral face of the top portion of the upper retainer 106b and the engaging pawls 106d are engaged with engaging holes 105i formed in the flange portion 105h of the inner panel 105 from inside of the flange portion 105h.

The engaging holes 105i are formed as plural elongated holes long in the vertical direction and by engaging the engaging pawls 106d with the engaging holes 105i, the upper/lower retainers 106b, 106c are coupled with the inner panel 105 in a floating condition, that is, such that they are freely movable and an air bag 108 is accommodated inside the inner panel 105 and the upper retainer 106b.

The air bag 108 is connected to a gas injection port (not shown) of the inflator 107 accommodated in the lower retainer 106c and expanded with high pressure gas injected from the inflator 107. By fixing a bracket 106g provided protrudedly on the outer peripheral face of the lower retainer 106c to a fixing member 109 with a fixing device 109a, the air bag module 106 is installed on a vehicle body.

Describing in detail with reference to FIG. 13, the inner panel 105 is formed integrally of resin softer than the outer panel 101, for example, olefin base elastomer and comprised of a sheet-like door reinforcement portion 105c welded on the back side of the outer panel 101 by vibration, frame-like fixing portion 105b provided continuously with the door reinforcement portion 105c by the hinge portions 105d divided to plural sections in the length direction of the outer panel 101 and a flange portion 105h (see for example, FIG. 12) provided protrudedly on the rear side of the fixing portion 105b. The flange portion 105h contains the aforementioned engaging holes 105i and on the top face of the door reinforcement portion 105c are provided protrudedly a plurality of protrusions (not shown) which are fused at the time of vibration welding thereby functioning as adhesive agent.

The inner peripheral face of the flange portion 105h is located on substantially the same line as the frame-like line 104a of the fracture portion 104 formed in the back side of the outer panel 101 and a distance from the outer peripheral face of the flange portion 105h to the engaging means 103 of the outer panel 101 is set to 80 mm or less, preferably, about 15 mm.

Although, in the hinge portion 105d which joins the door reinforcement portion 105c with the fixing portion 105b, the side of the occupant of the door reinforcement portion 105c is formed thinner, this thickness protects from a fracture even if a large force is applied to the front surface side of the outer panel 101. A fracture line 105e composed of a V-shaped groove is formed at a position matching the central line 104b of the fracture portion 104 substantially in the center of the door reinforcement portion 105c.

Because the fracture line 105e is hidden by the outer panel 101 and not exposed on the surface, it may be formed in the surface of the door reinforcement portion 105c and its thickness is set to 0.3-1.5 mm like the fracture portion 4, preferably 0.6-0.7 mm. Although the fracture portion 104 and the fracture line 105e are permitted to be formed when the outer panel 101 and the inner panel 105 are formed, they may be formed mechanically after their formation.

Upon installing the air bag module 106 on the inner side of the instrument panel 102, with the top faces of the door reinforcement portion 105c and the fixing portion 105b of the inner panel 105 kept in contact with the back side of the outer panel 101, they are positioned at a specified position and then by vibrating the outer panel 101 and the inner panel 105 relatively, the top face of the door reinforcement portion 105c is welded on the back side of the outer panel 101 by vibration so that they are integrated with each other.

The air bag module 106 in which the inflator 107 and the air bag 108 is accommodated in the upper/lower retainers 106b, 106c preliminarily is prepared and the engaging pawl 106d provided protrudedly on the outer peripheral face of the upper retainer 106b of the air bag module 106 is engaged with the engaging hole 105i in the inner panel 105 from inside of the flange portion 105h.

When covering the opening portion 102a with the outer panel 101 from the front surface side of the instrument panel 102 with this condition, the outer panel 101 is engaged in the opening portion 102a in the instrument panel 102 with the engaging means 103 on the rear side of the outer panel 101.

Although after that, the bracket 106g provided protrudedly on the lower retainer 106c of the air bag 106 is installed with the fixing device 109 on the vehicle side, because the inner panel 105 and the air bag module 106 are in the floating condition, any deviation of the mounting positions between the instrument panel 102 and the air bag module 106 can be absorbed. Therefore, mounting work of the air bag module is easily carried out and further, adjustment work on a gap with the opening portion 102a of the instrument panel 102 is not necessary.

On the other hand, if a vehicle collides and the inflator 107 is started by sensing its impact so that expansion of the air bag 108 is started, the door reinforcement portion 105c of the inner panel 105 is pushed up by expansion pressure of the air bag 108 as shown in FIG. 5.

Consequently, a gap between the engaging pawl 106d engaged with the engaging hole 105i in the inner panel 105 and the bottom end of the engaging hole 105i is diminished so that the engaging pawl 106d is engaged on the bottom end portion of the engaging hole 105i and thereby blocking the inner panel 105 from rising.

Although at this time, the non-expansion portion 101b of the outer panel 101 receives a pulling force in a direction to the center of the outer panel 101 as indicated with an arrow in FIG. 16, move of the non-expansion portion 101b and drop thereof into inside of the instrument panel 102 are prevented.

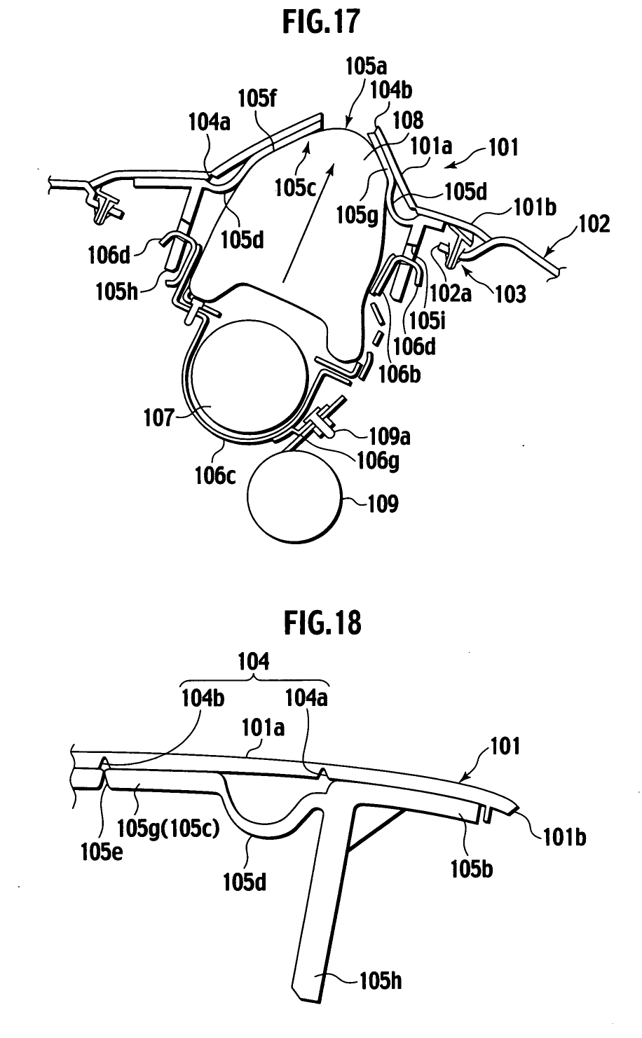

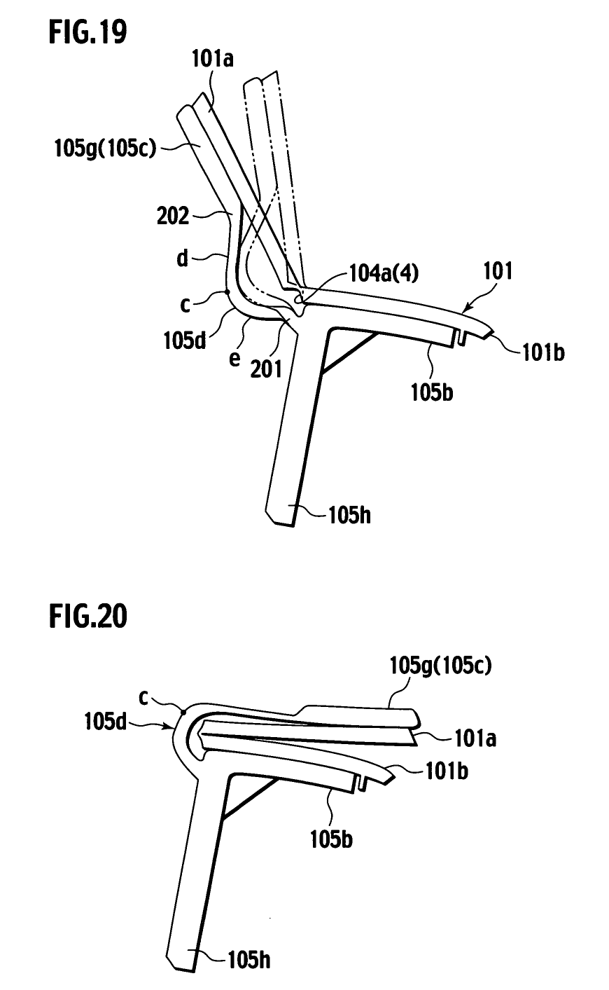

Because after that, as the air bag 108 is expanded further, the fracture line 105e in the door reinforcement portion 105c and the central portion 104b of the fracture portion 104 of the outer panel 101 are torn out as shown in FIGS. 17 and 19, the door reinforcement portion 105c is released upward around the hinge portion 105d and the non-expansion portion 101b of the outer panel 101 is joined with the opening edge of the opening portion 102a made in the instrument panel 102 by the engaging means 103. As a consequence, the door reinforcement portion 105c and the non-expansion portion 101b of the outer panel 101 are deformed into an arch shape so that the fracture portion 104 is fractured smoothly with the flange portion 105h engaged with the non-expansion portion 101b by the engaging pawl 106d as a fulcrum point.

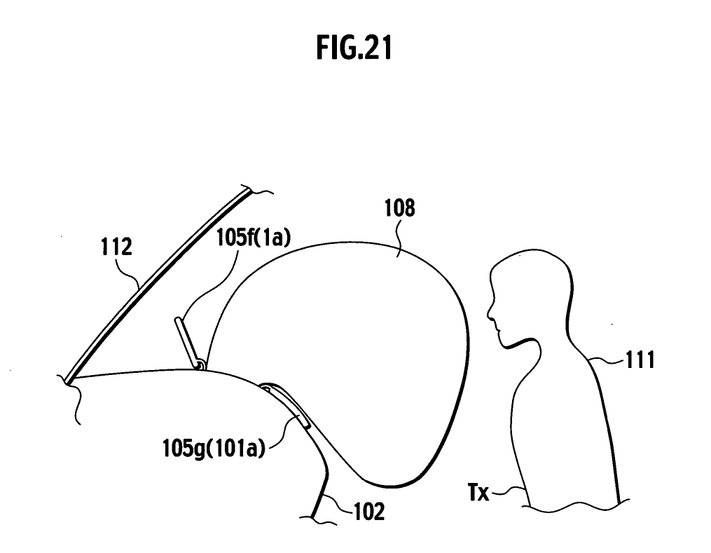

After that, the expansion of the air bag 108 is further progressed and if the air bag 108 is expanded completely as shown in FIG. 21 to be able to protect an occupant 111, because the hinge portion 105d is formed so that its thickness decreases gradually from the side of the fixing portion 105b to the side of the door reinforcement portion 105c, the expected door portion 101a is rotated together with the door reinforcement portion 105c of the inner panel 105 so that the expected door portion 101a of the outer panel 101 overlaps the non-expansion portion 101b as shown in FIG. 20.

Because as shown in FIG. 19, the hinge portion 105d is formed thicker on the side 201 of the fixing portion 105b and to be thinned gradually after that so that the side 202 of the door reinforcement portion 105c is the thinnest, parallel move (door slide) of the door reinforcement portion 105c as indicated with chain double-dashed line of FIG. 19 hardly occurs. An intermediate point c of the hinge portion 105d is located at a lower position and an upper point d on the side of the door reinforcement portion 105c of the hinge portion 105d is bent and deformed with twisting. Although a lower point e on the side of the fixing portion 105b of the hinge portion 105d is deformed, its deformation amount is small because it is formed thick.

As a consequence, the upper point d side on the side 202 of the door reinforcement portion 105c is bent more largely than the intermediate point c of the hinge portion 105d, so that a snap effect is generated and then, as shown in FIG. 20, the door reinforcement portion 105c is turned over along the top face of the instrument panel 102.

The hinge portion 105d having such a shape that it is formed to be thinned gradually from the side of the fixing portion 105b to the side of the door reinforcement portion 105c is preferred to be used as a hinge portion on the side of the divided door reinforcement portion 105g located on the side of the occupant 111.

As a result, with such a structure, the air bag 108 can be expanded more along the top face of the instrument panel 102 as indicated in FIG. 21 so that it is easy to be expanded to the stomach of the occupant 111.

Additionally, the expected door portion 101a as well as the door reinforcement portion 105c are turned back stably in a wide temperature range and as a consequence, a predetermined expansion characteristic of the air bag 108 can be obtained in a wide temperature range.

As evident from the above description, the hinge portion 105d on the side of the divided door reinforcement portion 105f nearer to a wind shield 112 does not need to adopt a shape in which the thickness decreases gradually from the side of the fixing portion 105b to the side of the door reinforcement portion 105c.

According to the present invention, as described above, the hinge portion of the cover body in the air bag apparatus is protruded in a direction of leaving the outer panel and formed so that its thickness decreases gradually from the side of the fixing portion of the inner panel to the side of the door reinforcement portion. As a consequence, the door reinforcement portion of the inner panel is pushed outward from inside by expansion of the air bag so that the closed loop shaped fracture portion provided on the outer panel is fractured and if the door reinforcement portion and the expected door portion rotate outward integrally, the fixing portion side of the hinge portion is not easily deformed because it is formed thicker and the door reinforcement portion side of the hinge portion is easily deformed because it is formed thinner. As a result, it comes that the intermediate point of the hinge portion is located at a lower position and the upper portion of the hinge portion is bent and deformed, so that the door reinforcement portion and the expected door portion can be turned back along the surface of the outer panel like an effect of snap. Further, fractured edge portions of hard resin never interfere with each other even in a wide temperature condition and choice for the material of the inner panel can be widened. Further with a simple structure in which the hinge portion is formed to be thinner from the side of the fixing portion to the side of the door reinforcement portion, the expansion behavior of the air bag can be stabilized. Thus, the present invention is suitable for a cover body of air bag apparatus which is an interior material for covering the air bag expansion side of an air bag module for protecting an occupant from an impact when a vehicle collides, particularly, a cover body of air bag apparatus comprised of an outer panel for covering the top face of the module and an inner panel disposed on the back side of this outer panel.

The entire contents of Japanese Patent Applications Nos. P2004-158324 (filed on May 27, 2004) and P2004-286868 (filed on Sep. 30, 2004) are incorporated herein by reference.

Although the invention has been described above by reference to certain embodiments of the invention, the invention is not limited to the embodiments described above. Modifications and variations of the embodiments descried above will occur to those skilled in the art, in light of the above teachings. The scope of the invention is defined with reference to the following claims.

1. A cover of air bag apparatus for covering an accommodated air bag and in which a projection port for the air bag to project when the air bag is expanded is formed, comprising:
a panel body made of resin including a door portion disposed opposing the air bag, a non-expansion portion which surrounds the door portion and a door peripheral portion defining the door portion and the non-expansion portion, containing a hinge opposing portion and a fracture portion to be fractured with a pressure when the air bag is expanded;
a backing member made of resin including a door fixing portion welded to the door portion in the form of a sheet, a non-expansion portion fixing portion welded to the non-expansion portion in the form of a sheet and a hinge portion which is deformable, connecting the door fixing portion with the non-expansion portion fixing portion and disposed substantially opposing the hinge opposing portion; and
a net body which is disposed across the hinge opposing portion and embedded integrally in a welding portion between the panel body and the backing member except a portion opposing the hinge opposing portion.

2. The cover of air bag apparatus according to claim 1 wherein the net body is provided with an allowance portion for connecting the side of the door portion with the side of the non-expansion portion with a longer distance than the shortest one at a place striding over the hinge opposing portion.

3. The cover of air bag apparatus according to claim 1 wherein the elongation characteristic of the net body is set to 40% higher than the elongation characteristic of the backing member or less.

4. The cover of air bag apparatus according to claim 2 wherein the elongation characteristic of the net body is set to 40% higher than the elongation characteristic of the backing member or less.

5. A manufacturing method of a cover of air bag apparatus for covering an accommodated air bag and in which a projection port for the air bag to project when the air bag is expanded is formed, wherein the cover of the air bag apparatus comprises:
a panel body made of resin including a door portion disposed opposing the air bag, a non-expansion portion which surrounds the door portion and a door peripheral portion defining the door portion and the non-expansion portion, containing a hinge opposing portion and a fracture portion to be fractured with a pressure when the air bag is expanded;
a backing member made of resin including a door fixing portion welded to the door portion in the form of a sheet, a non-expansion portion fixing portion welded to the non-expansion portion in the form of a sheet and a hinge portion which is deformable, connecting the door fixing portion with the non-expansion portion fixing portion and disposed substantially opposing the hinge opposing portion; and
a net body which is disposed across the hinge opposing portion and embedded integrally in a welding portion between the panel body and the backing member except a portion opposing the hinge opposing portion,
the manufacturing method of the cover of the air bag apparatus, comprising the steps of:
disposing the net body having a pitch different from the pitch of the rib between ribs provided protrudedly in a grid shape on any one of the panel body and the backing member and the other member of the panel body and the backing member;
making the ribs into a sliding contact with the other member, and
welding integrally the ribs with the other member, so that the net body is embedded in a welding portion between the panel body and the backing member.

6. A cover of air bag apparatus for covering an air bag accommodated in a folded condition and in which a projection port from which the air bag is projected when the air bag is expanded is formed, the cover comprising:
an outer panel of resin and an inner panel disposed on the back side on the air bag side of the outer panel and so softer than the outer panel that it is deformable,
wherein the outer panel comprises an expected door portion as an expansion portion opposing the air bag and a closed loop shaped fracture portion which sections between the expected door portion and a non-expansion portion and is fractured with a pressure at the time of the expansion of the air bag;
wherein the inner panel comprises a fixing portion to be fixed to the non-expansion portion, a door reinforcement portion to be fixed to the expected door portion and a hinge portion which is deformable and transverses the fracture portion to join the fixing portion with the door reinforcement portion integrally; and
wherein the hinge portion is expanded in a direction of leaving the outer panel and formed to be thinned gradually from the side of the fixing portion to the side of the door reinforcement portion.

7. The cover of air bag apparatus according to claim 6 wherein the door reinforcement portions are provided back and forth in the direction of vehicle traveling with the air bag mounted on the vehicle and the both door reinforcement portions comprise each hinge portion while at least one of which located on the side of an occupant is formed to be thinned gradually from the side of the fixing portion to the side of the door reinforcement portion.
